(19) United States
(12) Patent Application Publication
(10) Pub. No.: US 2009/0134026 A1
(43) Pub. Date: May 28, 2009

(54) Gas sensor and method for the production thereof

(76) Inventor: Markus Langenbacher, Lenzkirch (DE)

Correspondence Address: MUIRHEAD AND SATURNELLI, LLC, 200 FRIBERG PARKWAY, SUITE 1001, WESTBOROUGH, MA, 01581, US

(21) Appl. No.: 11/661,223

(22) PCT Filed: Aug. 12, 2005
(86) PCT No.: PCT/EP2005/008774

§ 371 Date: May 23, 2008

(30) Foreign Application Priority Data
Aug. 27, 2004 (DE) 10 2004 041 620.6

(51) Int. Cl. G01N 27/407; B05D 5/12

(52) U.S. Cl. 204/424; 427/77

(57) ABSTRACT

A gas sensor has a condenser with a layered structure, including at least two electroconductive layers forming electrodes, at least one of the layers being at least partially permeable to the gas to be detected. A gas-sensitive layer produced by means of a sol-gel technique is arranged between the electrodes, the composition and structure of the layer being adapted to the gas to be detected and the desired measuring region. Further, a method is disclosed for producing such a gas sensor.

The present invention relates to a gas sensor according to the definition of the species in Claim 1 and a method for producing a gas sensor according to the definition of the species in Claim 12.

Gas sensors produced using various methods are known in manifold embodiments and for various gases.

EP 0 403 994 A1 describes a capacitive moisture sensor, i.e., a sensor for water vapor, which is implemented as a capacitor in layered construction. A moisture-sensitive polymer film is situated as a dielectric material between two metallic electrodes, one of which is formed by a moisture-permeable metal layer. More or less water vapor diffuses into the polymer film as a function of the ambient moisture, whereby its dielectric constant is impaired. Measurements of the capacitance of the capacitor formed by the two metal layers and the polymer film therefore allow conclusions to be drawn about the water vapor content of the surroundings. Using gas sensors of this type based on polymer films, water vapor is detectable in principle in the range from approximately 0% to 100% relative humidity (RH). However, the measurement range below 1% RH is not accessible with sufficient precision for meaningful measurements because of inadequate water vapor sensitivity of the polymer layers.

For this reason, more sensitive, porous layers, in particular aluminum oxide layers in the case of water vapor, have already been used for some time as gas-sensitive layers. Thus, U.S. Pat. No. 2,237,006 describes an electric hygrometer, in which, as a layer sensitive to water vapor, aluminum oxide is situated between two metal layers, one of which is permeable to water vapor, in a sensor implemented in layered construction. The water vapor content, i.e., the humidity, is determined on the basis of the change of the ohmic resistance of the aluminum oxide layer caused by the adsorption of water vapor in this layer.

Gas sensors of this type have an expanded detection range in relation to sensors based on polymers. However, their production, in which the porosity of the metal oxide layers used is typically generated by anodic oxidation of the metal employed, requires a high outlay for manufacturing technology. In addition, they do not have long-term stability and may only be used in a restricted temperature range. Thus, measuring gas temperatures above 100° C. are not accessible to this species of sensor.

Furthermore, a moisture sensor in which the electrodes are not arranged in a layered construction is known from KR 00 23937. The layer sensitive to water vapor is applied to the electrodes using sol-gel technology. The production of such gas sensors and/or moisture sensors is simplified in comparison to the use of a moisture-permeable cover electrode. The measurement range extends in these sensors to a range from approximately 20% to 90% RH in the case of detection of water vapor.

The present invention is thus based on the object of providing a gas sensor, in particular a moisture sensor, using which small gas concentrations, known as gas traces, may be detected and which may also be used at higher ambient temperatures and/or temperatures of the measuring gas.

Furthermore, the object is to provide a simple production method for such a gas sensor.

The idea on which the present invention is based is to implement a gas sensor as a type of capacitor in layered construction, in which the electrodes are formed by at least two electrically conductive layers, at least one of which is at least partially permeable to the gas to be detected, and to situate a gas-sensitive layer produced using sol-gel technology between these electrodes.

In sol-gel technology, firstly a colloidal sol is formed from inorganic salts, metal-organic compounds, or alkoxides using organic solvents or water and special compounds, in particular stabilizing additives. This sol may be applied to a substrate by various coating processes. For example, it is converted into an amorphous gel by hydrolysis and condensation reactions. This gel is dried and may additionally be thermally processed, e.g., by pyrolysis. It may then be provided in its oxidized form.

This technology allows comparatively simple mixing of various components of the gas-sensitive layer, such as different metal oxides. In addition, the porosity of the finished gas-sensitive layer and thus its gas adsorption rate and/or gas sensitivity may be regulated to a certain extent by suitable sol components and adequate process control. In connection with the contact areas in the layered construction between the gas-sensitive layer and the electrodes adjoining it, which are large in comparison to the structure of interlocking electrode combs, a high-sensitivity gas sensor thus results, which may be used at an operating temperature of up to 300° C. with significantly higher measuring gas temperatures than known gas sensors, which are based on anodically oxidized aluminum (up to 100° C.) or polymers (up to 200° C.).

The electrical impedance of the porous, gas-sensitive layer of the sensor is analyzed in the gas sensor according to the present invention, as is typical in capacitive gas sensors. This impedance is a function of the concentration of the gas to be detected in the surroundings of the gas sensor and/or the quantity of the gas adsorbed in the gas-sensitive layer. As an alternative to analyzing the impedance of the gas sensor, there is also the possibility of solely recording capacitance or resistance changes.

As indicated above, the use of sol-gel technology allows a comparatively simple variation of the components of the gas-sensitive layer and, within certain boundaries, the variation of the structure of this layer. One embodiment of the present invention therefore provides that the gas-sensitive layer produced using sol-gel technology is tailored in its composition and structure to the gas to be detected and to the desired measurement range. In particular, the gas-sensitive layer may also be tailored to the detection of water vapor. Furthermore, the gas-sensitive layer is tailored in particular to the detection of gas traces, in particular of trace moisture, i.e., water vapor traces. For example, aluminum, silicon, titanium, magnesium, vanadium, zirconium, barium, or iron and/or their oxides come into consideration as components of the sol for such a trace moisture sensor. Furthermore, potassium, lithium, carbon, or tin are possible components. Both individual metal oxides and also mixtures of various metal oxides may be used.

In an advantageous embodiment of the present invention, the gas-sensitive layer has an optimized pore size distribution, in particular pore diameters predominantly less than 1 μm. In addition, a gas-sensitive layer having a total layer thickness of less than 1 μm is particularly advantageous. A rapid response behavior of the gas sensor results in this way.

In a refinement of the present invention, the gas-sensitive layer is additionally thermally treated after its drying. In contrast to conventional sensors having anodically oxidized metal oxide layers, good long-term stability of the gas sensor thus results.

At least one of the electrically conductive layers forming the electrodes is preferably made of metal or metal alloy, because these typically have a comparatively high electrical conductivity and may be deposited using technologies known per se, such as thermal vapor deposition.

In a further embodiment of the present invention, one of the electrically conductive layers is situated on an insulating substrate. This layer is used as a carrier for the gas sensor and increases its mechanical stability.

In an advantageous refinement of the present invention, an insulator layer is situated between the first conductive layer and the gas-sensitive layer. This is advantageous because the total impedance of the gas sensor produced may be shifted into an impedance range favorable for the selected analysis electronics by the insulator, which represents an impedance in series to the sensitive layer in this case. Furthermore, the long-term stability of the sensor configuration in the event of temporarily occurring high ambient humidities may be increased due to the insulator.

In an advantageous embodiment of the present invention, a reference electrode, which is electrically connected to the second electrically conductive layer, which is at least partially gas-permeable, is situated on the substrate electrically insulated from the first conductive layer. In this way, both electrically conductive layers may be contacted from the side of the substrate facing toward the gas sensor. In particular, the possibility arises of contacting these two layers using printed conductors applied to the substrate.

Furthermore, in a refinement of the present invention, a temperature sensor is integrated in the gas sensor. This temperature sensor is used for simultaneously determining the ambient temperature, so that the ascertained values may be used for a subsequent correction of the temperature-dependent gas sensor signals. Alternatively, the possibility exists of using the ascertained temperature data in a computing unit integrated in the gas sensor or connected thereto for the immediate correction of the gas sensor signals. In addition, active temperature regulation of the gas sensor using heating and cooling elements known per se based on the ascertained temperature values is also conceivable. The integrated temperature sensor may also be used as a heating element to heat the gas sensor actively and cyclically with the aid of the computing unit.

The method according to the present invention for producing a gas sensor is based on the idea of first applying at least one first electrically conductive layer to an insulating substrate, on which a gas-sensitive layer is then deposited using sol-gel technology, which is in turn coated using an electrically conductive material which is at least partially permeable to the gas to be detected.

The sol or the gel is preferably applied to the first electrically conductive layer using simple methods such as draw or centrifugal coating, spraying, screen printing, or the like.

In a refinement of the production method, the gas-sensitive layer formed using sol-gel technology is additionally thermally treated after the gel formed is dried as usual. This essentially causes the loss of the solvent present in the layer and may result in sintering and pyrolysis of the layer. The gas-sensitive layer acquires long-term stability in this way.

The components of the sol and/or the gel and the structure of the gas-sensitive layer made thereof are advantageously tailored to the gas to be detected and the desired measurement range, in particular to the detection of gas traces such as trace moisture. A porosity of the sol-gel layer of more than 15% has been shown to be advantageous for this purpose. The main components of the sol for producing a trace moisture sensor are the oxides of the metals aluminum, silicon, or titanium.

In a refinement of the manufacturing method, before the sol or gel is applied, an insulator layer is applied to at least one first conductive layer using methods known per se, in particular using chemical vapor deposition or physical vapor deposition, or also using sol-gel technology. This provides the advantage that the total impedance of the gas sensor having the insulator may be shifted into an impedance range suitable for the measurement electronics by the selection of the insulator material and its thickness. In addition, the first electrically conductive layer forming the base electrode is protected from environmental influences.

In a further embodiment of the production method, at least one electrically conductive layer is applied by vapor deposition, sputtering, or electrical deposition of metal or a metal alloy.

In the following, the present invention is explained in greater detail on the basis of figures.

FIG. 1 shows a schematic illustration of a top view of a gas sensor according to the present invention (sandwich design),

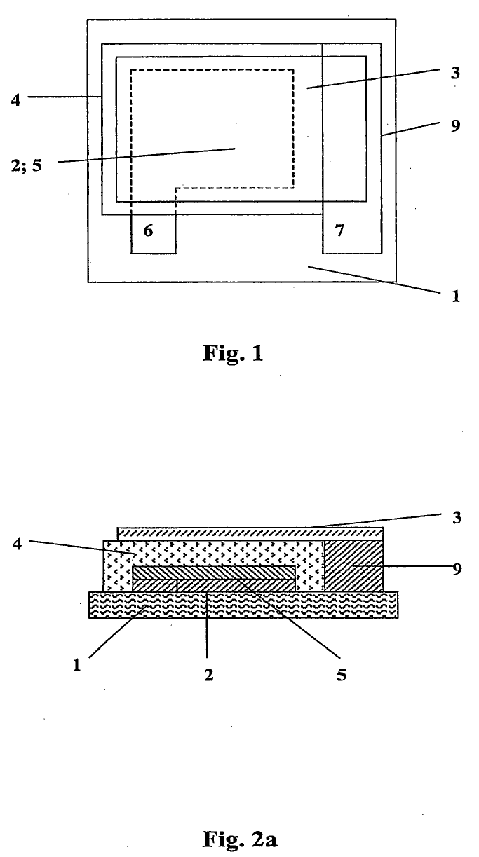

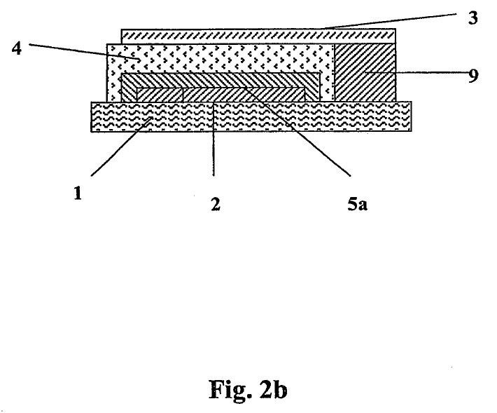

FIG. 2a shows a cross section through the schematic illustration of the gas sensor from FIG. 1,

FIG. 2b shows a cross section through a gas sensor in which the insulator layer is implemented in such a way that it encloses the first conductive layer,

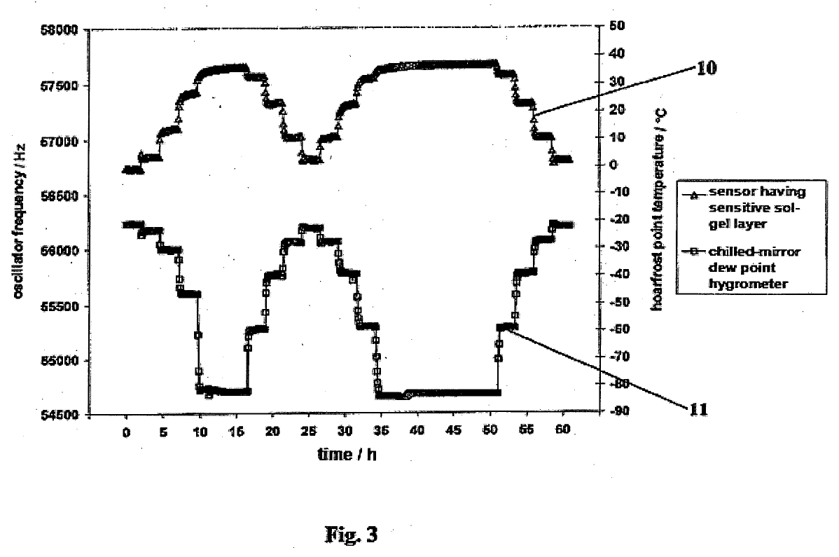

FIG. 3 shows the calibration of a trace moisture sensor according to the present invention with the aid of a chilled-mirror dew point level hygrometer,

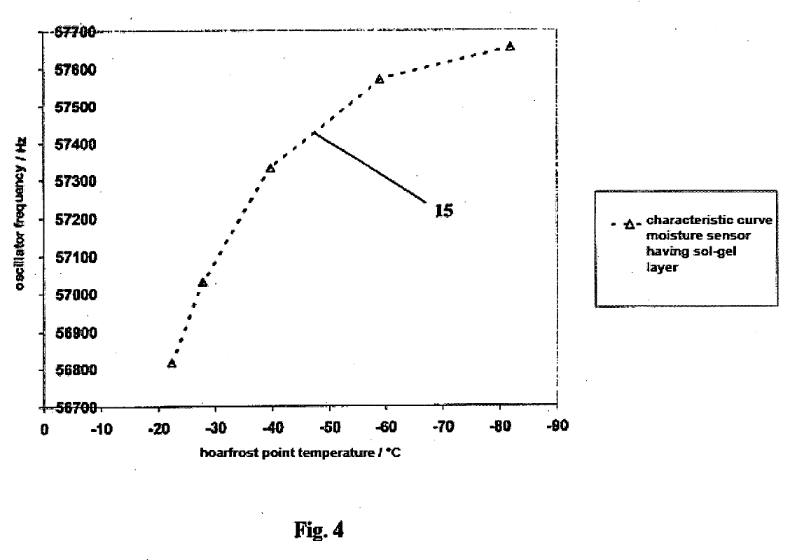

FIG. 4 shows the characteristic curve of the trace moisture sensor calibrated on the basis of the measurement curves illustrated in FIG. 3,

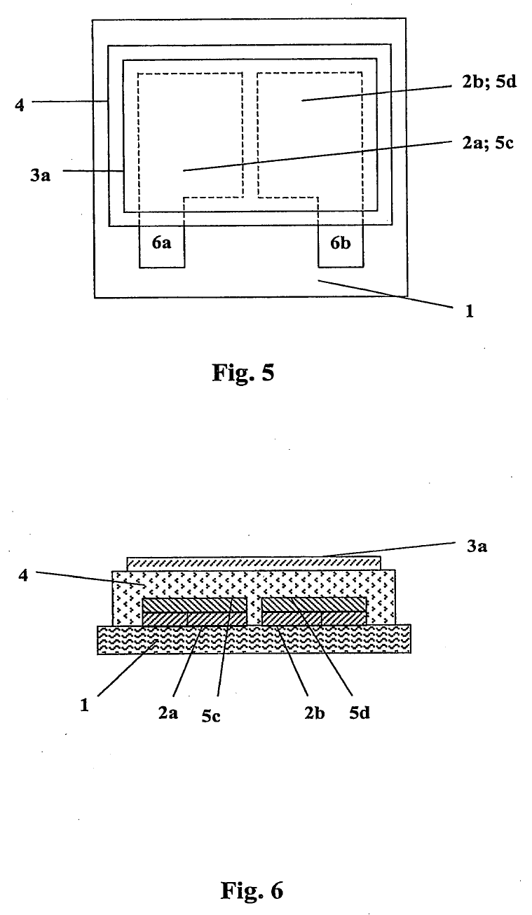

FIG. 5 shows a schematic illustration of a top view of a further exemplary embodiment of a gas sensor according to the present invention (butterfly design),

FIG. 6 shows a cross section through the schematic illustration of the gas sensor from FIG. 5.

The schematic illustrations in FIG. 1 and FIG. 2a show an outline illustration of an exemplary embodiment of a gas sensor according to the present invention and a cross section through it, respectively. A first conductive layer 2, which is applied in particular by vapor deposition of metal, is situated on substrate 1. An insulator layer 5, which prevents the diffusion of molecules of the gas to be detected from gas-sensitive layer 4 to first conductive layer 2 and thus protects it from environmental influences, is provided on this first electrically conductive layer 2. Furthermore, the total impedance of the gas sensor is influenced in the desired way by insulator layer 5. Gas-sensitive layer 4 has been applied using sol-gel technology described above. A reference electrode 9 is situated on substrate 1 directly laterally adjoining gas-sensitive layer 4. This reference electrode is electrically connected to second electrically conductive layer 3, which is at least partially permeable to the gas to be detected.

As may be inferred from FIG. 1, the first electrically conductive layer and the reference electrode partially project past the remaining layers of the gas sensor, so that these projecting areas are available as a contacting area 6 for first electrically conductive layer 2 and a contacting area 7 for the second electrically conductive layer. These contacting areas directly adjoin the surface of substrate 1, so that they may advantageously be contacted via sensor pins connected using solder, for example.

In operation of the gas sensor, molecules of the gas to be detected diffuse via open lateral surfaces of the gas-sensitive layer or through second electrically conductive layer 3, which is at least partially gas-permeable, into gas-sensitive layer 4 and are adsorbed therein. The dielectric constant and the ohmic resistance of gas-sensitive layer 4 are thus impaired. The changes in these material properties are recorded by measuring the impedance of the capacitor formed by electrically conductive layers 2 and 3 and gas-sensitive layer 4 and insulator 5 and allow conclusions to be drawn about the gas concentration in the environment.

The components and the structure of the gas-sensitive layer are to be tailored to the gas to be detected and the desired measurement range, as described above.

FIG. 2b shows an alternative embodiment variation of a gas sensor according to the present invention, in which insulator layer 5a is implemented in such a way that it also encloses first electrically conductive layer 2 on its lateral surfaces. The protection of the first conductive layer and/or the base electrode from environmental influences is reinforced in this way.

FIG. 3 shows the measurement data of a trace moisture sensor, in which gas-sensitive layer 4 was tailored to the detection of water vapor in an environment having a relative humidity in the range from 0.001% to 5%. To analyze the impedance change on the basis of the increase or decrease of the water vapor content in the environment, the natural frequency of a freely oscillating electrical oscillating circuit was determined, whose frequency-determining component is formed by the gas sensor described above. In FIG. 3, this natural frequency of the electrical oscillating circuit, referred to as the oscillator frequency, is plotted as a function of time. Measurement curve 10 represents the oscillator frequency of the trace moisture sensor system formed by the electrical oscillating circuit, while in contrast curve 11 represents the hoarfrost point temperature in the environment of the gas sensor determined in parallel using a chilled-mirror dew point hygrometer.

The hoarfrost point temperature of a measured gas represents a typical measured variable for the trace moisture in trace moisture sensor systems. In the measurements shown, which were performed at 25° C., a hoarfrost point temperature of −20° C. corresponds to a relative humidity of 3.25% RH and a hoarfrost point temperature of −80° C. corresponds to a relative humidity of 0.002% RH.

By linking the two measured curves illustrated in FIG. 3, characteristic curve 15 shown in FIG. 4 results for the moisture sensor having a sol-gel layer, which assigns the oscillator frequency of the trace moisture sensor system directly to a hoarfrost point temperature and thus to a water vapor concentration. As may be inferred from the characteristic curve, a moisture content in the range from 0.002% RH to 3.25% RH is detectable using a trace moisture sensor according to the present invention. In addition, a moisture content below 0.002% RH may be determined with appropriate design of the trace moisture sensor.

FIG. 5 shows a schematic illustration of a top view of a further exemplary embodiment of a gas sensor according to the present invention in the butterfly design. This is also a gas sensor including a capacitor in layered construction, but three electrically conductive layers 2a, 2b, and 3a are provided instead of two, as previously, electrically conductive layers 3a, which is connected to the environment as shown in the sectional illustration in FIG. 6, again being at least partially permeable to the gas to be detected. Electrically conductive layers 2a, 2b, and 3a are situated at a distance from one another and gas-sensitive layer 4, which is produced using sol-gel technology, is situated between them, which is again tailored in its composition and structure to the gas to be detected and the desired measurement range. Insulator layers 5c and 5d are situated on each of electrically conductive layers 2a and 2b, analogously to the preceding exemplary embodiments. Insulating substrate 1 is also provided in this exemplary embodiment to increase the mechanical stability of the gas sensor.

The advantage of this embodiment variation is that electrically conductive layer 3a, which is in contact with the external environment and is referred to as the cover electrode, does not need to be contacted. The capacitor on which the gas sensor is based is formed here by both electrically conductive layers 2a and 2b and insulator layers 5c and 5d, which are located between them, and gas-sensitive sol-gel layer 4. A reference electrode 9, as is indicated in FIGS. 1, 2a, and 2b, may therefore be dispensed with.

Instead, both electrically conductive layers 2a and 2b are implemented in such a way that they project beyond the remaining layers of the gas sensor and the projecting areas are available as contacting areas 6a and 6b for electrically conductive layer 2a or 2b. As indicated in FIG. 5, these contacting areas 6a and 6b directly adjoin the surface of substrate 1, so that they may again advantageously be contacted via sensor pins connected using solder, for example.

The possibility of simpler contacting of the gas sensor according to the present invention arises in this way, because cover electrode 3a does not need to be contacted. However, in comparison to the gas sensors illustrated in FIG. 2a or 2b, if electrically conductive layers 2a and 2b together cover an equally large area of substrate 1 as electrically conductive layer 2, and insulator layers 5, 5a, 5c, and 5d and gas-sensitive layer 4 are each approximately equally thick, a capacitance results for the gas sensor from FIG. 6 which is only approximately one fourth of the capacitance of the gas sensor from FIG. 2a or 2b. The resulting reduced sensitivity of such a gas sensor may be compensated for by a corresponding correction of the dimensions of the various layers of the gas sensor from FIG. 6, however.

### LIST OF REFERENCE NUMERALS

1 substrate
2 first electrically conductive layer
2a electrically conductive layer
2b electrically conductive layer
3 second electrically conductive layer
3a electrically conductive layer
4 gas-sensitive layer
5 insulator layer
5a insulator layer
5c insulator layer
5d insulator layer
6 contacting area of the first electrically conductive layer
6a contacting area of electrically conductive layer 2a
6b contacting area of electrically conductive layer 2b
7 contacting area of the second electrically conductive layer
9 reference electrode
10 oscillator frequency of the trace moisture sensor system
11 hoarfrost point temperature ascertained using chilled-mirror dew point hygrometer
15 characteristic curve of trace moisture sensor having sol-gel layer

1. A gas sensor, comprising:
a capacitor in layered construction having at least two electrically conductive layers forming electrodes, at least one of which is at least partially permeable to a gas to be detected,
wherein a gas-sensitive layer produced using sol-gel technology is situated between the electrodes and wherein the gas-sensitive layer is tailored in its composition and structure to the gas to be detected and a desired measurement range.

2. The gas sensor as recited in claim 1, wherein the gas-sensitive layer produced using sol-gel technology is tailored to the detection of water vapor.

3. The gas sensor as recited in claim 1, wherein the gas-sensitive layer produced using sol-gel technology is tailored to the detection of gas traces.

4. The gas sensor as recited in claim 1, wherein the gas-sensitive layer has a pore size distribution, wherein pore diameters are predominantly less than 1 μm.

5. The gas sensor as recited in claim 1, wherein a total layer thickness of the gas-sensitive layer is less than 1 μm.

6. The gas sensor as recited in claim 1, wherein the gas-sensitive layer is thermally treated.

7. The gas sensor as recited in claim 1, wherein at least one of the electrically conductive layers forming the electrodes is made of metal or a metal alloy.

8. The gas sensor as recited in claim 1, further comprising:
an insulator layer situated between at least one first electrically conductive layer and the gas-sensitive layer.

9. The gas sensor as recited in claim 1, wherein one of the electrically conductive layers is situated on an insulating substrate.

10. The gas sensor as recited in claim 9, further comprising:
a reference electrode, which is electrically conductively connected to the second electrically conductive layer, which is at least partially gas-permeable, that is situated on the insulating substrate and electrically insulated from the first electrically conductive layer.

11. The gas sensor according to claim 1, further comprising:
a temperature sensor integrated in the gas sensor.

12. A method for manufacturing a gas sensor, in which at least one first electrically conductive layer is applied to an insulating substrate, a gas-sensitive layer is applied to the first electrically conductive layer and the gas-sensitive layer is in turn coated with an electrically conductive material, which is at least partially permeable to the gas to be detected, wherein the gas-sensitive layer is manufactured using sol-gel technology.

13. The method for producing a gas sensor as recited in claim 12, wherein the sol or the gel is applied to the first electrically conductive layer using at least one of: draw or centrifugal coating, spraying, and screen printing.

14. The method for producing a gas sensor as recited in claims 12, wherein the gas-sensitive layer is thermally treated in addition to drying as part of the sol-gel technology.

15. The method for producing a gas sensor as recited in claim 12, wherein the components of the sol and/or the gel and the structure of the gas-sensitive layer formed therefrom are tailored to the gas to be detected and the desired measurement range.

16. The method for producing a gas sensor as recited in claim 12, wherein, before the sol or gel is applied, an insulator layer is applied to at least one first electrically conductive layer using at least one of: chemical vapor deposition, physical vapor deposition and sol-gel technology.

17. The method for producing a gas sensor as recited in claim 12, wherein at least one electrically conductive layer is applied by at least one of: vapor deposition, sputtering, and galvanic deposition of metal or a metal alloy.

18. The gas sensor as recited in claim 1, further comprising:
an insulator layer situated between at least one first electrically conductive layer and the gas-sensitive layer;
a reference electrode, which is electrically conductively connected to the second electrically conductive layer, which is at least partially gas-permeable, that is situated on the insulating substrate and electrically insulated from the first electrically conductive layer; and
a temperature sensor integrated in the gas sensor.

19. A gas sensor, comprising:
a capacitor having at least two electrically conductive layers, at least one of the two electrically conductive layers being at least partially gas permeable; and
a gas-sensitive sol-gel layer disposed between the at least two electrically conductive layers, wherein the gas-sensitive sol-gel layer has a porosity that is greater than 15% and includes at least one of: a metal and a metal oxide.

20. The gas sensor as recited in claim 19, further comprising:
an insulator layer disposed between at least one of the two electrically conductive layers and the gas-sensitive layer.
